(19) United States
(12) Patent Application Publication
(10) Pub. No.: US 2008/0168899 A1
(43) Pub. Date: Jul. 17, 2008

(54) SEPARATION AND COLLECTION OF PARTICULATES FROM AN AIR STREAM

(75) Inventor: William K. Decker, Cambridge, WI (US)

Correspondence Address: FOLEY & LARDNER LLP, 150 EAST GILMAN STREET, P.O. BOX 1497, MADISON, WI, 53701-1497, US

(73) Assignee: American Farm Implement & Specialty, Inc.

(21) Appl. No.: 11/622,755

(22) Filed: Jan. 12, 2007

(51) Int. Cl. B01D 45/02; B01D 45/14; B01D 46/46; B01D 50/00; B01D 51/00; B01D 53/24

(52) U.S. Cl. 95/22; 55/383; 55/385.1; 55/413; 55/419; 95/35

(57) ABSTRACT

A device for separating and collecting particulates from an air stream is provided. The device comprises a separation chamber housing a plurality of particulate separators. Each particulate separator in the plurality of particulate separators includes an intake port, a mechanical separation unit, a discharge port, and an outlet port. An air stream enters the particulate separator through the intake port. The mechanical separation unit is capable of separating particulates from the air stream and discharging the separated particulates through the discharge port. Clean air is expelled through the outlet ports of the plurality of particulate separators. The device further comprises an air stream entrance port capable of receiving the air stream, an air stream exit port capable of receiving the clean air, and a particulate reservoir capable of collecting discharged particulates.

### FIELD

The subject of the disclosure relates generally to a device for separating particulates from an air stream. More specifically, the disclosure relates to a method, apparatus, and system for separation and collection of particulates from a vacuum-generated or other air stream without the use of a filter.

### BACKGROUND

Many industrial processes create airborne particulates. For example, filing systems, sawing systems, cleaning systems, grinding systems, particulate transportation systems, etc., can all create unwanted airborne particulates. Such particulates can include, but are not limited to, grain, cement powder, dirt, rice, plastic, metal chips, sparks, filings, paper fiber, sawdust, and other powders. If left in the air, these particulates can lead to lost product, damage to a vacuum generator or other equipment, unsanitary conditions, an unclean work environment, environmental harm, fires, respiratory disorders, and/or other unsafe conditions.

The railroad industry is a prime example of an industry which creates unwanted airborne particulates. Railroad tracks can become flattened and/or misshapen as multi-ton trains repeatedly travel along them. This track distortion requires trains to expend more energy while traveling along the tracks and adds to the cost of railway operation. If left in disrepair, distorted railroad tracks can also lead to train derailments and other accidents. To avoid these consequences, the railroad industry periodically re-grinds railroad tracks back into their original shape via one or more grinders mounted to a special railway car. As a result of the grinding, a large amount of hot metal shavings, sparks, and other particulates are generated. Traditional railroad track grinding systems utilize a vacuum-generated air stream to guide generated particulates toward one or more paper filters. The one or more paper filters are used to remove the particulates from the air stream before they reach the vacuum generator.

In particulate transportation systems, particulates can be moved from a first location to a second location via an air stream. The air stream, which can be provided by a vacuum generator, can flow from the first location to the second location to the vacuum generator. Ideally, all of the transported particulates are removed from the air stream and deposited at the second location. However, often many particulates remain in the air stream and are transported to the vacuum generator where damage can occur. These remaining particulates can be due to particulate size, vacuum strength, etc. To remedy this problem, traditional particulate transportation systems utilize a filter located between the second location and the vacuum generator to remove any remaining particulates from the air stream.

The use of filters in particulate generating and/or transporting systems has several drawbacks. In a railroad track grinding system, sparks can cause paper filters to catch on fire. In a particulate transportation system, particulates caught in a filter are often disposed of, resulting in lost product. In addition, filters in general are subject to becoming clogged with particulates. A clogged filter must either be cleaned or replaced to prevent dissipation of vacuum strength. Filter cleaning can cause trapped particulates to be released into a surrounding environment and filter replacement can be expensive due to the cost of replacement filters. In addition, both filter cleaning and filter replacement can result in down time for the system in which the filter is located. Thus, there is a need for a device capable of separating particulates from an air stream without the use of a filter. Further, there is a need for a device capable of collecting the separated particulates in a reservoir which can be easily and rapidly emptied or replaced.

### SUMMARY

A device for separating and collecting particulates from an air stream is provided. The device comprises a separation chamber housing a plurality of particulate separators. Each particulate separator in the plurality of particulate separators includes an intake port, a mechanical separation unit, a discharge port and an outlet port. An air stream enters the particulate separator through the intake port. The mechanical separation unit is in fluid communication with the intake port and capable of separating particulates from the air stream. The particulates are discharged by the mechanical separation unit through the discharge port. Clean air is expelled through the outlet ports of the plurality of particulate separators. The device further comprises an air stream entrance port, an air stream exit port and a particulate reservoir. The air stream entrance port is in fluid communication with the separation chamber and capable of receiving the air stream. The air stream exit port is in fluid communication with the outlet ports and capable of receiving the clean air from the outlet ports. The particulate reservoir is positioned with respect to the discharge ports such that it is capable of collecting the particulates discharged through the discharge ports.

Another exemplary embodiment provides a system for separating and collecting particulates from an air stream. The system comprises a particulate source in fluid communication with an air stream entrance port. The system further comprises a separation chamber, an air stream exit port, a vacuum generator, and a particulate reservoir. The separation chamber is in fluid communication with the air stream entrance port and houses a plurality of particulate separators as described with reference to the device. The air stream exit port is in fluid communication with the outlet ports of the plurality of particulate separators and is capable of receiving clean air therefrom. The vacuum generator is capable of creating a vacuum which draws the air stream into the air stream entrance port, through the plurality of particulate separators, and into the air stream exit port. The particulate reservoir is capable of collecting the particulates discharged through the discharge ports of the plurality of particulate separators.

Another exemplary embodiment provides a method of collecting particulates from a railroad track grinding apparatus. The method comprises drawing, via a vacuum, an air stream including particulates generated by a railroad track grinding apparatus into an air stream entrance port. Particulates are separated from air in the air stream using a plurality of particulate separators as described with reference to the device. The particulates are collected in a particulate reservoir and clean air is expelled through an air stream exit port in fluid communication with the outlet ports of the plurality of particulate separators.

Other principal features and advantages will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings, wherein like numerals will denote like elements.

FIG. 1 is a perspective view of a device for separating and collecting particulates from an air stream in accordance with an exemplary embodiment.

FIG. 2 is a cross-sectional view of a particulate separator in accordance with an exemplary embodiment.

FIG. 3 is a side view of a device for separating and collecting particulates from an air stream in accordance with an exemplary embodiment.

FIG. 4 is a perspective view of a particulate separator arrangement in accordance with an exemplary embodiment.

FIG. 5 is a first perspective view of an enclosed device for separating and collecting particulates from an air stream in accordance with an exemplary embodiment.

FIG. 6 is a second perspective view of an enclosed device for separating and collecting particulates from an air stream in accordance with an exemplary embodiment.

FIG. 7 is a system for separating and collecting particulates from an air stream in accordance with an exemplary embodiment.

FIG. 8 is a flow diagram illustrating operations performed in the separation and collection of particulates from an air stream in accordance with an exemplary embodiment.

### DETAILED DESCRIPTION

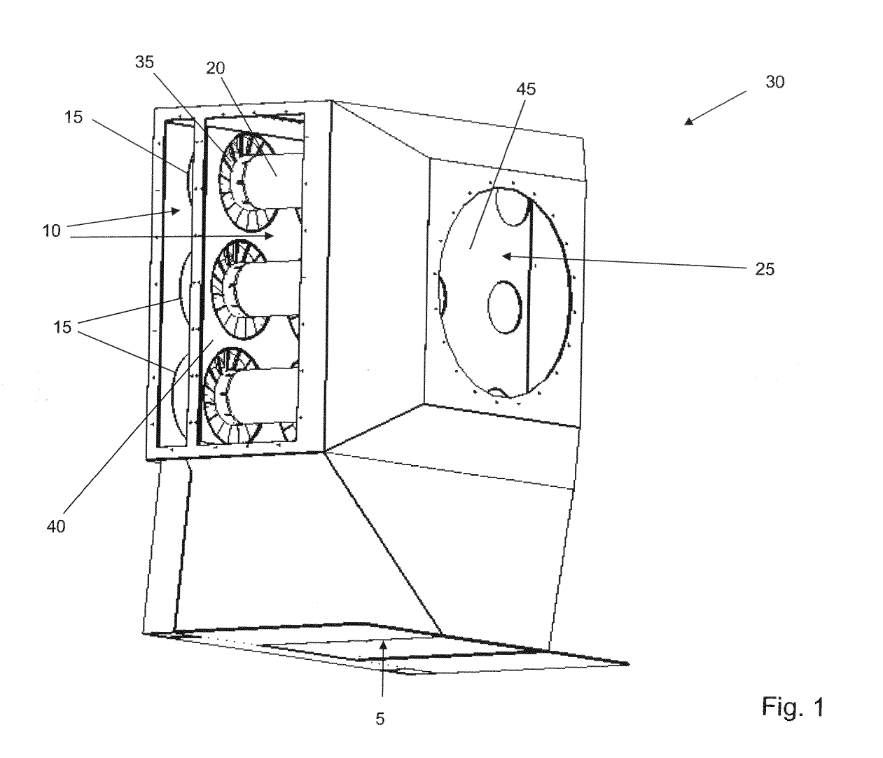

FIG. 1 illustrates a device 30 for separating and collecting particulates from an air stream in accordance with an exemplary embodiment. The device 30 includes an air stream entrance port 5, a separation chamber 10, a plurality of particulate separators 15, a plurality of outlet conduits 20, and an air stream exit port 25. Components of the device 30 can be fabricated out of non-flammable or other materials depending on the embodiment. An air stream with particulates can enter the device 30 via the air stream entrance port 5. The air stream can be conducted from the air stream entrance port 5 into the separation chamber 10 in fluid communication with the air stream entrance port 5. Air from the air stream can be further conducted from the separation chamber 10 into any particulate separator within the plurality of particulate separators 15. Each particulate separator can be in fluid communication with the separation chamber 10.

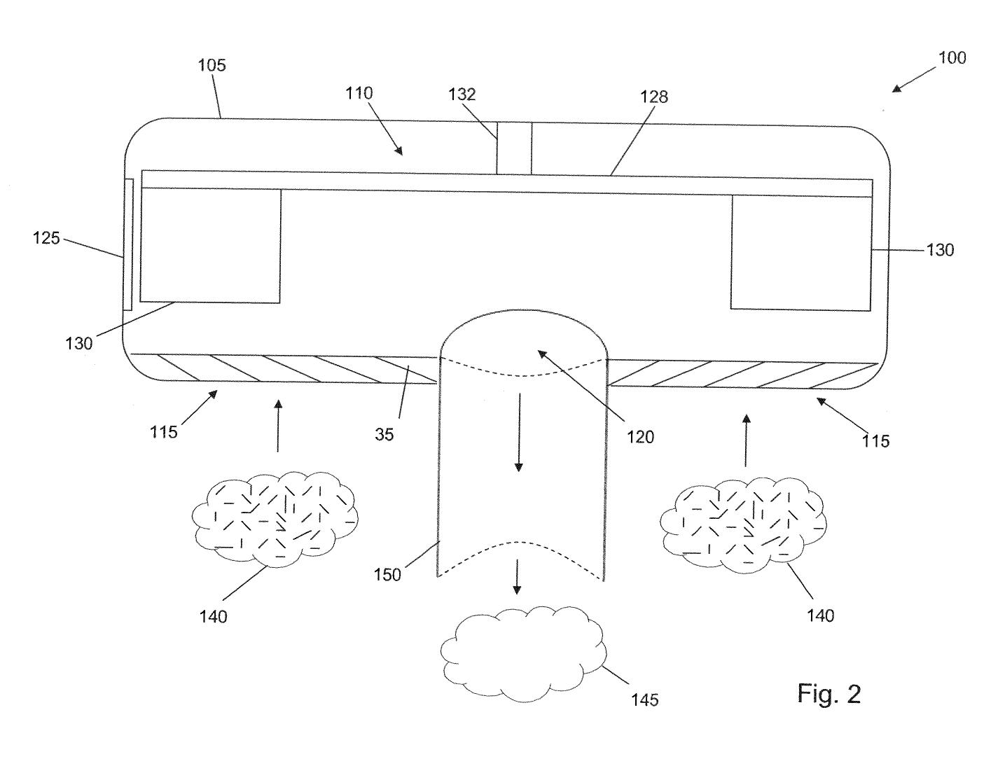

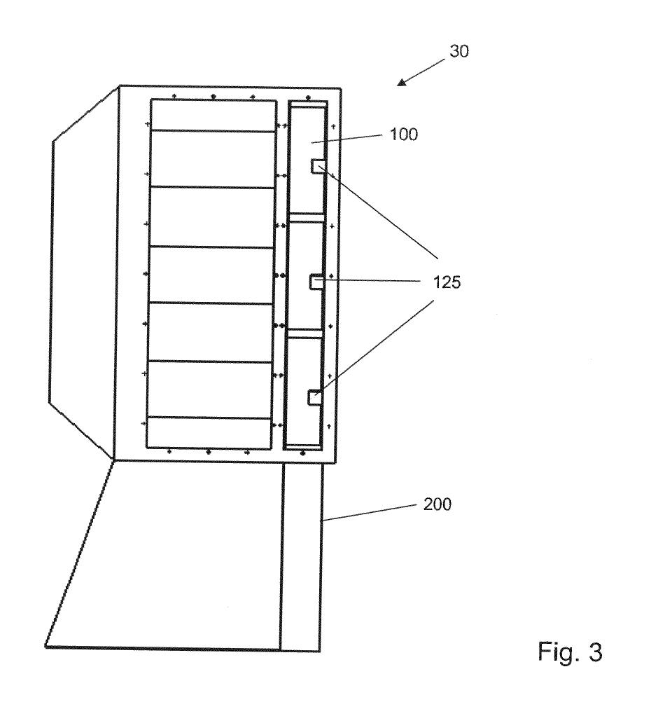

A guide wall 40 within the separation chamber 10 can be used to ensure that air from the air stream is only able to enter a particulate separator via an intake port of the particulate separator. Each particulate separator within the plurality of particulate separators 15 can include one or more fins 35 located in the intake port of the particulate separator. The one or more fins 35 can guide air from the air stream such that it comes into contact with a mechanical separation unit. The mechanical separation unit can be a non-filtering apparatus capable of separating particulates from an air stream. The mechanical separation unit can also be capable of discharging the particulates through a discharge port of the particulate separator. A particulate separator is described in more detail with reference to FIG. 2. Particulates which are discharged through the discharge port of the particulate separator can be collected in a particulate reservoir. A particulate reservoir is described in more detail with reference to FIG. 3.

The plurality of particulate separators 15 can be in fluid communication with the plurality of outlet conduits 20 such that a clean air stream can flow through outlet ports of the plurality of particulate separators 15 into the plurality of outlet conduits 20. The clean air stream can flow from the plurality of outlet conduits 20 through the air stream exit port 25 which is in fluid communication with the plurality of outlet conduits 20. A dividing wall 45 can be used to separate the separation chamber 10 from the air stream exit port 25. The dividing wall 45 can also ensure that air from the air stream passes through the plurality of particulate separators 15 prior to reaching the air stream exit port 25.

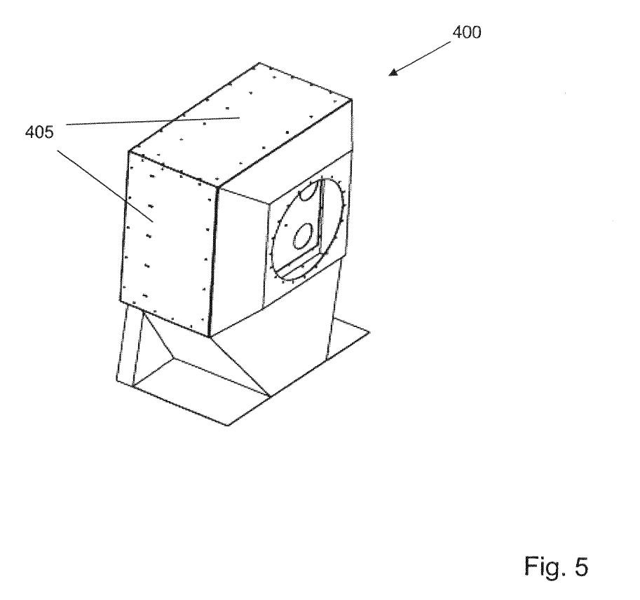

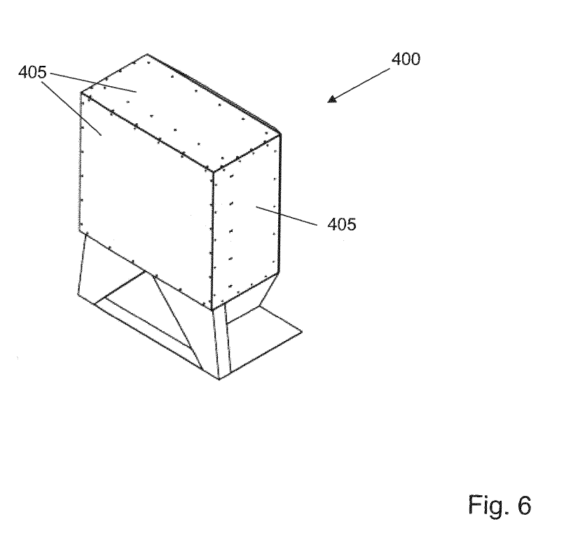

In an exemplary embodiment, the air stream can be provided by a vacuum in fluid communication with the air stream exit port 25 of the device 30. Alternatively, the air stream can be provided by a vacuum within the device, a blower in fluid communication with the air stream entrance port, or any other device capable of providing an air stream. In another exemplary embodiment, the separation chamber 10 and the plurality of particulate separators 15 can be enclosed by a plurality of side walls (not shown). The plurality of side walls can be used to create an airtight seal between the device 30 and an ambient atmosphere. A particulate separation and removal device including side walls is illustrated with reference to FIGS. 5 and 6.

FIG. 2 is a cross-sectional view of a particulate separator 100 in accordance with an exemplary embodiment. The particulate separator 100 includes a base 105, a mechanical separation unit 110, an intake port 115, an outlet port 120, and a discharge port 125. Components of the particulate separator 100 can be fabricated out of non-flammable or other materials depending on the embodiment. An air stream with particulates 140 can enter the particulate separator 100 via the intake port 115. The intake port 115 can include one or more fins 35. The one or more fins 35 can be angled and/or curved such that a centrifugal force of the air stream with particulates 140 can direct the air stream with particulates 140 toward the mechanical separation unit 110 and away from the outlet port 120.

The mechanical separation unit 110 includes an impeller 128 and one or more paddles 130. In an alternative embodiment, the mechanical separation unit can include a plurality of impellers, each of which can include one or more paddles. In another alternative embodiment, the impeller can include a leading edge or groove such that air encountered by the impeller can be directed toward the one or more paddles. The impeller 128 and the one or more paddles 130 can rotate about an axis of a mounting stem 132 such that the one or more paddles 130 encounter the air stream with particulates 140 as directed by the one or more fins 35. In an exemplary embodiment, rotation of the mechanical separation unit 110 can be provided by a vacuum that is generating the air stream with particulates 140. Alternatively, rotation of the mechanical separation unit can be provided by a particulate separator power source. The mechanical separation unit 110 can be mounted to the base 105 via the mounting stem 132. The mounting stem 132 can include a plurality of bearings such that the impeller 128 can rotate with minimal friction. In an exemplary embodiment, the impeller 128 can be mounted on two ball bearings.

Particulates from the air stream with particulates 140 can be guided to and discharged through the discharge port 125 by the one or more paddles 130. The discharge port 125 can be an aperture in the base 105 of the particulate separator 100. In an alternative embodiment, the base of the particulate separator can include a plurality of discharge ports. A clean air stream 145 with particulates removed can be conducted to the outlet port 120 of the particulate separator 100 by a vacuum or other force creating the air stream. The clean air stream 145 can be conducted from the outlet port 120 into an outlet conduit 150 in fluid communication with the outlet port 120. The clean air stream 145 can flow from the outlet conduit 150 to the air stream exit port 25 described with reference to FIG. 1.

The particulate separator described with reference to FIG. 2 can also be any variation of an air pre-cleaner. An air pre-cleaner can be a non-filtering device used to remove particulates from air such that clean air can be received by an intake of an apparatus such as a combustion engine. Air pre-cleaners can also be non-filtering devices used to remove particulates from air such that clean air can be received be a filtration system. Air pre-cleaners are described in detail in U.S. Pat. Nos. 5,022,903, 5,449,391, 5,505,756, 6,264,712, 6,348,077, 6,361,574, and 6,709,479, the entire disclosures of which are hereby incorporated by reference.

FIG. 3 is a side view of a device 30 for separating and collecting particulates from an air stream in accordance with an exemplary embodiment. Particulates which are discharged through the discharge port 125 of a particulate separator 100 can be collected in a particulate reservoir 200. In an exemplary embodiment, discharged particulates can travel along a particulate channel prior to being deposited in the particulate reservoir 200. The particulate reservoir 200 can be a bin, bag, or other receptacle capable of collecting discharged particulates. The particulate reservoir 200 can also be detachable such that discharged particulates can rapidly and easily be disposed of or recycled. In addition, the device 30 can include a stopper mechanism such that the particulate reservoir 200 can be emptied or replaced without causing any down time in a system in which the device 30 is used. The particulate reservoir 200 can be fabricated out of a non-flammable or other material depending on the embodiment. In an exemplary embodiment, gravity can be used to ensure that discharged particulates fall into the particulate reservoir 200. Alternatively, a vacuum or blower can be used to direct discharged particulates from the discharge ports into the particulate reservoir.

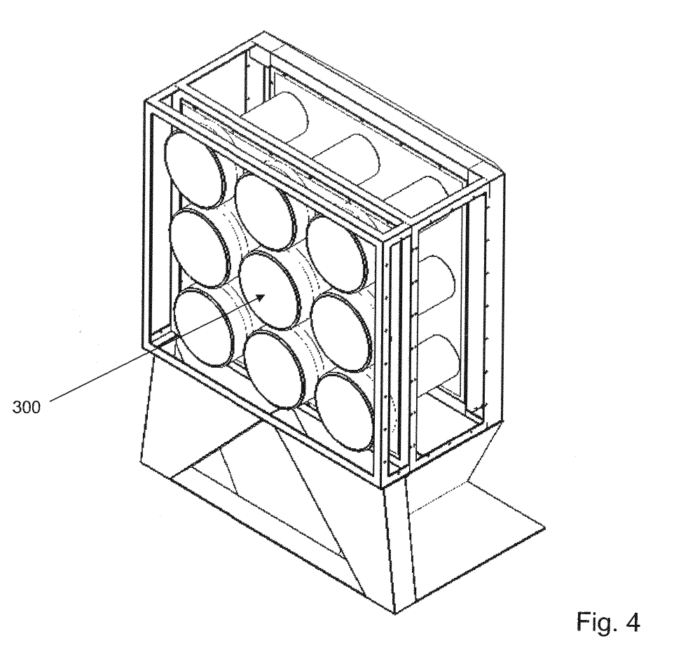

FIG. 4 is a perspective view of a particulate separator arrangement 300 in accordance with an exemplary embodiment. The particulate separator arrangement 300 includes nine particulate separators arranged in a three-by-three array. In an alternative embodiment, any number of particulate separators can be included in the device. In another alternative embodiment, the particulate separators can be arranged in any configuration capable of allowing the particulate separators to separate particulates from an air stream. For example, the particulate separators can be arranged in a line, circle, triangle, or any other geometric configuration.

FIG. 5 is a first perspective view of an enclosed device 400 for separating and collecting particulates from an air stream in accordance with an exemplary embodiment. FIG. 6 is a second perspective view of the enclosed device 400 for separating and collecting particulates from an air stream in accordance with an exemplary embodiment. The enclosed device 400 includes a plurality of side walls 405. The plurality of side walls 405 can be used to create an airtight seal between the enclosed device 400 and an ambient atmosphere. As such, an air stream can flow through the enclosed device 400 without contaminating or being contaminated by the ambient atmosphere.

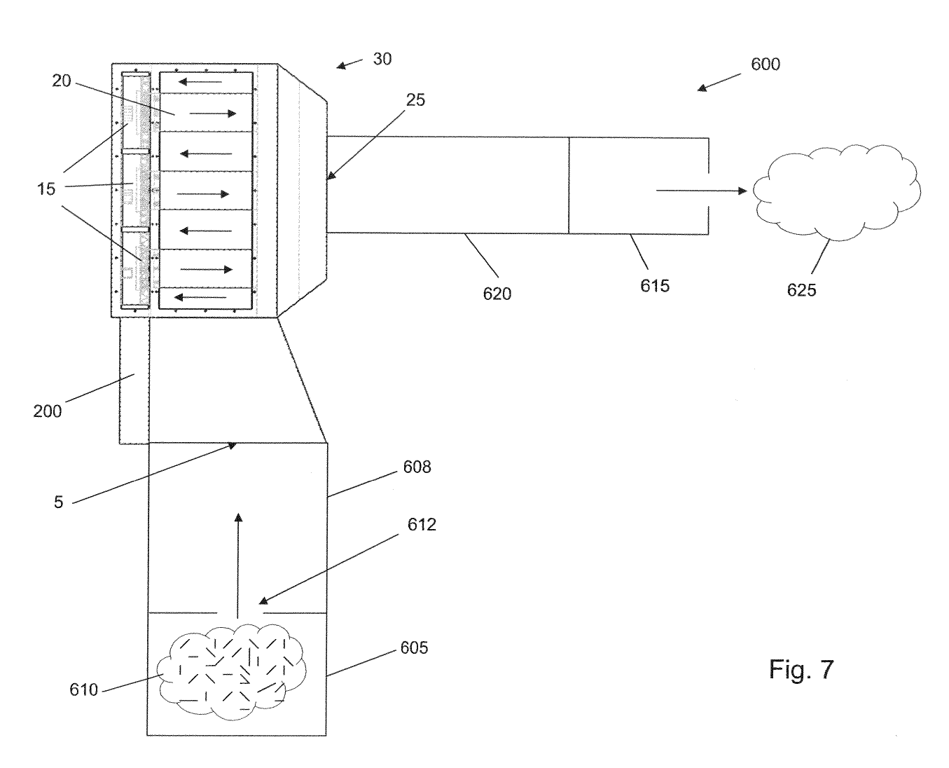

FIG. 7 illustrates a system 600 for separating and collecting particulates from an air stream in accordance with an exemplary embodiment. The system includes a particulate source 605, a device 30 for separating and collecting particulates from an air stream, and a vacuum generator 615. The device 30 can be in fluid communication with the particulate source 605 via a sealed particulate conduit 608. The device 30 can be in fluid communication with the vacuum generator 615 via a sealed vacuum conduit 620. The particulate source 605 can be one or more grinders of a railroad track or other grinding apparatus, a filing system, a sawing system, a cleaning system, or any other apparatus or system capable of producing airborne particulates. The particulate source 605 can also be an accumulation of particulates at a first location within a particulate transport system. The second location (i.e., destination) of such a particulate transport system can be somewhere between a particulate outlet port 612 of the particulate source 605 and an air stream entrance port 5 of the device 30. Particulates resulting from the particulate source 605 can include, but are not limited to, grain, cement powder, dirt, rice, plastic, metal chips, sparks, filings, paper fiber, sawdust, and other powders.

The vacuum generator 615 can be any device capable of creating a vacuum such that an air stream 610 with particulates can be drawn from the particulate source 605 through the system 600. The air stream 610 can be drawn from the particulate source 605 into the sealed particulate conduit 608 in fluid communication with the particulate source 605. The air stream 610 can be further drawn from the sealed particulate conduit 608 into the device 30 via the air stream entrance port 5. Particulates can be separated from the air stream 610 by the plurality of particulate separators 15 and collected in the particulate reservoir 200 as described with reference to FIGS. 1-3. The vacuum can conduct a clean air stream 625 from the plurality of particulate separators 15 through the plurality of outlet conduits 20. The clean air stream 625 can be conducted from the plurality of outlet conduits 20 through the air stream exit port 25 and into the sealed vacuum conduit 620. The clean air stream 625 can further be conducted from the sealed vacuum conduit 620 into and through the vacuum generator 615.

In an exemplary embodiment, the particulate source 605, the particulate outlet port 612, the sealed particulate conduit 608, the air stream entrance port 5, the separation chamber, the intake ports of the plurality of particulate separators 15, the outlet ports of the plurality of particulate separators 15, the plurality of outlet conduits 20, the air stream exit port 25, the sealed vacuum conduit 620, and the vacuum generator 615 can all be in fluid communication with one another. In another exemplary embodiment, with the exception of a vacuum outlet through which the clean air stream 625 exits the vacuum generator 615, the entire system 600 can be sealed from an ambient environment.

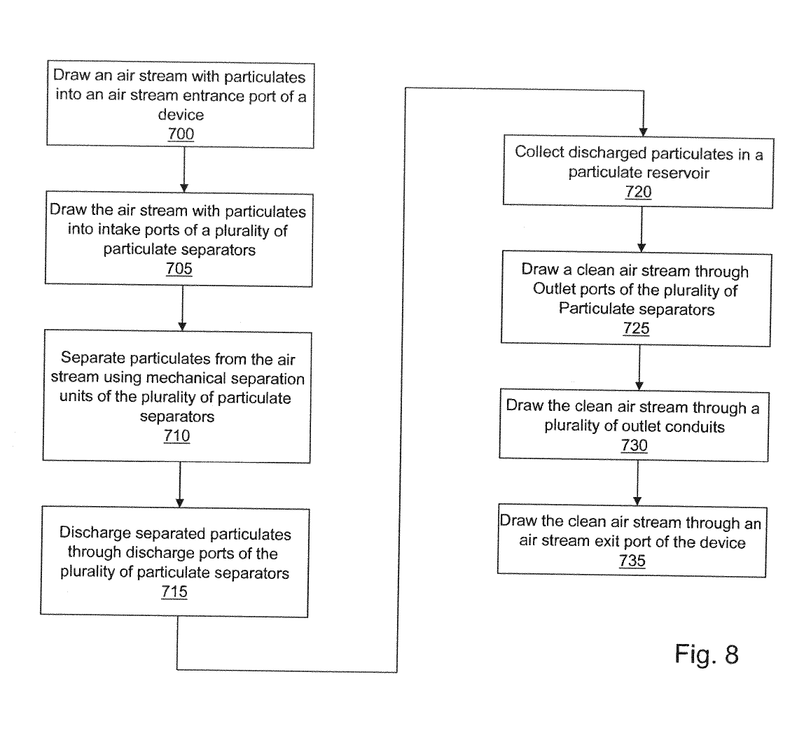

FIG. 8 is a flow diagram illustrating operations performed in the separation and collection of particulates from an air stream according to an exemplary embodiment. Additional, fewer, or different operations may be performed depending on the embodiment. Also, the use of a flow diagram is not meant to be limiting with respect to the order of operations performed. In an operation 700, an air stream with particulates is drawn into an air stream entrance port of a device. The device can be the device described with reference to FIGS. 1-7. The air stream with particulates can be drawn by a vacuum, a blower, or any method capable of creating and/or drawing an air stream. In an operation 705, the air stream with particulates is drawn into intake ports of a plurality of particulate separators. The plurality of particulate separators can be those described with reference to FIG. 2. In an operation 710, particulates are separated from the air stream using mechanical separation units of the plurality of particulate separators. In an operation 715, the separated particulates are discharged through discharge ports of the plurality of particulate separators. In an operation 720, the discharged particulates are collected in a particulate reservoir. The particulate reservoir can be the particulate reservoir described with reference to FIG. 3. In an operation 725, a clean air stream is drawn through outlet ports of the plurality of particulate separators. The clean air stream is drawn through a plurality of outlet conduits in an operation 730, and in an operation 735, the clean air stream is drawn through an air stream exit port of the device.

For the purposes of this disclosure and unless otherwise specified, “a” or “an” means “one or more.” All patents, applications, references and publications cited herein are incorporated by reference in their entirety to the same extent as if they were individually incorporated by reference.

The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A device for separating and collecting particulates from an air stream, the device comprising:
a separation chamber housing a plurality of particulate separators, wherein each particulate separator in the plurality of particulate separators comprises
an intake port through which an air stream enters the particulate separator;
a mechanical separation unit capable of separating particulates from the air stream, wherein the mechanical separation unit is in fluid communication with the intake port;
a discharge port through which the mechanical separation unit discharges the particulates; and
an outlet port through which clean air is expelled;
an air stream entrance port in fluid communication with the separation chamber, wherein the air stream entrance port is capable of receiving the air stream;
an air stream exit port in fluid communication with the outlet ports, wherein the air stream exit port is capable of receiving the clean air from the outlet ports; and
a particulate reservoir capable of collecting the particulates discharged through the discharge ports.

2. The device of claim 1, wherein each particulate separator in the plurality of particulate separators further includes one or more fins in the intake port capable of directing the air stream toward the mechanical separation unit.

3. The device of claim 1, wherein each particulate separator in the plurality of particulate separators further includes a base, and further wherein the discharge port is located on the base.

4. The device of claim 1, wherein the plurality of particulate separators comprises nine particulate separators.

5. The device of claim 4, wherein the nine particulate separators are positioned in a three-by-three array.

6. The device of claim 1 further comprising one or more side walls capable of sealing the device from an ambient atmosphere outside the device.

7. The device of claim 1, further comprising a plurality of outlet conduits in fluid communication with the outlet ports, wherein the plurality of outlet conduits are capable of conducting the clean air to the air stream exit port.

8. The device of claim 1, wherein the mechanical separation unit comprises an impeller rotatably mounted in fluid communication with the intake port.

9. The device of claim 8, wherein the impeller is rotatably mounted on ball bearings.

10. A system for separating and collecting particulates from an air stream, the system comprising:
a particulate source through which an air stream is capable of flowing, wherein the particulate source is in fluid communication with an air stream entrance port;
a separation chamber in fluid communication with the air stream entrance port and housing a plurality of particulate separators, wherein each particulate separator in the plurality of particulate separators comprises
an intake port through which the air stream enters the particulate separator;
a mechanical separation unit capable of separating particulates from the air stream, wherein the mechanical separation unit is in fluid communication with the intake port;
a discharge port through which the mechanical separation unit discharges the particulates; and
an outlet port through which clean air is expelled;
an air stream exit port in fluid communication with the outlet ports, wherein the air stream exit port is capable of receiving the clean air from the outlet ports; and
a particulate reservoir capable of collecting the particulates discharged through the discharge ports.

11. The system of claim 10, wherein the air stream entrance port is in fluid communication with a particulate outlet port of the particulate source.

12. The system of claim 11, wherein the air stream entrance port is connected to the particulate outlet port via a sealed particulate conduit.

13. The system of claim 10, wherein the particulate source is a railroad track grinding apparatus.

14. The system of claim 10, wherein the particulate source is a first location in a particulate transporting system.

15. The system of claim 14, wherein the particulate transporting system comprises a grain transporting system.

16. The system of claim 10, further comprising a vacuum generator capable of creating a vacuum which draws the air stream into the air stream entrance port, through the plurality of particulate separators, and into the air stream exit port.

17. The system of claim 10, further comprising a plurality of outlet conduits in fluid communication with the outlet ports, wherein the plurality of outlet conduits are capable of conducting the clean air to the air stream exit port.

18. A method of collecting particulates from a railroad track grinding apparatus, the method comprising:
drawing, via a vacuum, an air stream including particulates generated by a railroad track grinding apparatus into an air stream entrance port;
separating the particulates from the air stream using a plurality of particulate separators, wherein each particulate separator in the plurality of particulate separators comprises
an intake port through which the air stream enters the particulate separator;
a mechanical separation unit capable of separating the particulates from the air, wherein the mechanical separation unit is in fluid communication with the intake port;
a discharge port through which the mechanical separation unit discharges the particulates, and
an outlet port through which clean air is expelled;
collecting the particulates in a particulate reservoir; and
expelling the clean air through an air stream exit port in fluid communication with the outlet ports.

19. The method of claim 17, wherein the mechanical separation unit comprises an impeller.

20. The method of claim 18, wherein the impeller comprises one or more paddles.
